(19) United States
(12) Patent Application Publication
(10) Pub. No.: US 2010/0029392 A1
(43) Pub. Date: Feb. 4, 2010

(54) TORQUE TRANSMISSION MEANS FOR THE ROTATIONALLY FIXED CONNECTION OF A SHAFT AND A ROTOR

(75) Inventors: Jens Müller, Bonn (DE); Jürgen Kellers, Haltern (DE)

Correspondence Address: FAY SHARPE LLP, 1228 Euclid Avenue, 5th Floor, The Halle Building, Cleveland, OH, 44115, US

(73) Assignee: ZENERGY POWER GMBH, Rheinbach (DE)

(21) Appl. No.: 12/530,526

(22) PCT Filed: Mar. 14, 2007
(86) PCT No.: PCT/EP2007/002253

§ 371 Date: Sep. 9, 2009

(51) Int. Cl. F16D 3/06; H02K 55/00

(52) U.S. Cl. 464/80

(57) ABSTRACT

A torque transmission device for connecting, in a rotationally fixed manner, a shaft and a rotor of a rotating machine which has superconducting turns and which is coolable in order to create the superconducting state of these turns, having a torque-loadable hollow body which has a rotation axis and ends in a shaft connection at the shaft end and in a rotor connection at the rotor end, wherein, between the shaft connection and the rotor connection, the hollow body has a compensation area, which can expand in the axial direction, between the shaft connection and the rotor connection, in order to compensate for axial length changes resulting from temperature differences.

This application claims priority to and the benefit of the filing date of International Application No. PCT/EP2007/002253, filed Mar. 14, 2007, which application is hereby incorporated by reference into the specification of this application.

The invention relates to a torque transmission means for rotationally fixed connection of a shaft and a rotor of a rotating machine which has superconducting turns and can be cooled in order to create the superconducting state of these turns, having a torque-loadable hollow body which can rotate about a rotation axis and opens into a shaft connection at the shaft end and into a rotor connection at the rotor end.

U.S. Pat. No. 6,873,079 B2 discloses a rotating machine in the form of an electric motor, which has a stator and a rotor, which can rotate about a rotation axis, within the tubular stator. The rotor is provided with superconducting turns and is cooled to below 100 Kelvin, in order that the superconducting turns change to a superconducting state. The rotor is rigidly connected to a shaft, which is pushed into the hollow body, via a torque transmission means comprising a hollow body formed from a plurality of parts. One of the hollow body parts is tubular and is connected by means of a rotor connection to the rotor, and another hollow body part is connected to the shaft by means of a shaft connection. The two hollow body parts are manufactured from stainless steel and are connected to one another at their ends via steel flanges. Four brackets, which are opposite one another in pairs, are in each case welded to the end faces of the two steel flanges. Each pair of brackets has an intermediate layer of an insulating element composed of glass-fiber-reinforced plastic, in order to prevent heat conduction from the hollow body, which is connected to the shaft, to the rotor. The insulating elements comprise short cylindrical plastic pieces, whose end faces are screwed to mutually opposite limbs of the brackets. The brackets are arranged concentrically about the rotation axis in order that, when a torque is introduced, the insulating elements are only compression-loaded or tension-loaded between the opposite brackets, since the insulating elements would be destroyed if shear-loaded.

### SUMMARY OF INVENTION

In accordance with the present invention, provided is a torque transmission means which is of simple design, can be assembled easily and allows reliable transmission of the torque, even when there are major temperature differences, during operational use.

According to differing aspects of the invention, this can be achieved in that between the shaft connection and the rotor connection, the hollow body has a compensation area, which can expand in the axial direction, between the rotor connection and the shaft connection, in order to compensate for axial length changes resulting from temperature differences.

In the torque transmission means according to the invention, the compensation area of the hollow body makes it possible to compensate for all the axial stresses which occur as a result of the temperature difference between those areas which are necessarily cooled to temperatures of, for example, below 100 K in the case of high-temperature superconductors, and the shaft, which is generally at room temperature. By way of example, these stresses can occur as a result of contraction of the rotor when the rotor is being cooled down using a cooling apparatus. The compensation area which is provided in the design of the torque transmission means makes it possible to compensate for the length change of the rotor when the rotor cools down, with the latter experiencing this length change while or after cooling down to the temperatures which are required for superconducting operational use. This also makes it possible to compensate for expansions resulting from a temperature increase at the end of the shaft in a warm environment.

The length contraction of the rotor is in this case preferably adapted by the shape of the compensation area. In the compensation area, the hollow body is preferably provided with at least one fold which extends around the rotation axis. The fold is in this case used to absorb and to compensate for the axial stresses which may occur. The fold advantageously allows an elastic length change of the torque transmission means in the axial direction, as a result of which the hollow body can be compressed or expanded in the compensation area. The configuration of the torque transmission means according to the invention with at least one fold considerably lengthens the effective distance for heat conduction between the shaft connection and the rotor connection, thus decreasing the overall thermal conductivity of the torque transmission means. In the compensation area, the hollow body is preferably in the form of a bellows. In the compensation area, it may be curved alternately outwards and inwards, successively, in the axial direction, or folded, to produce a plurality of folds, thus increasing the effective length of the torque transmission means for heat transmission, while at the same time also increasing the maximum torque that can be transmitted.

According to other aspects of the invention, the folds are formed by fold walls which are opposite one another in a V-shape or wedge-shape. The fold walls are connected to one another by a fold back which is preferably curved, and in particular is rounded. A fold back may connect two folds to one another. The fold walls may include an acute angle. When the rotor cools down, the curvature of the fold back can change, and the fold walls can bend, in order to compensate for the axial strain. According to another aspect of the invention, at least three fold walls are arranged in the compensation area.

At least in the compensation area, the hollow body is composed of a poorly thermally conductive material, thus additionally making it possible to reduce the heat which is introduced from the shaft to the rotor that has cooled down. The torque transmission means may be produced entirely or partially from a fiber-reinforced plastic, for example a glass-fiber-reinforced plastic, which has the advantage that the plastic part of the hollow body formed in this way can expand and contract in the axial direction and is poorly thermally conductive, in particular in the compensation area. The reinforcing fibers are expediently embedded in the plastic such that they overlap, crossed over, in order to allow the torsion forces which act on the hollow body during operational use to be transmitted well. In this case, this may be either a fabric composed of reinforcing fibers which overlap crossed over or reinforcing fiber layers which are in layers one above the other, crossed over.

The fiber material may also be embedded in the plastic, laid or wound in spiral shape around the rotation axis. Furthermore, the entire element can be designed such that the internal area can be evacuated, in order to achieve better thermal insulation.

A cylindrical section may be provided between the compensation area and the rotor connection in order that the compensation area is located closer to the shaft connection than to the rotor connection. Since, during operational use, the shaft connection is normally warmer than the rotor connection, the compensation area is then at least partially heated by the shaft, as a result of which the compensation area, which is composed of plastic material, remains more flexible than the area of the hollow body at the rotor connection, despite the rotor having cooled down.

The shaft connection and/or the rotor connection may be formed by metal elements. The shaft connection and/or the rotor connection may be metal rings or may be designed to be annular. The shaft connection and/or the rotor connection can be screwed to the hollow body. The metal elements may also be embedded in the plastic part in order to connect the latter to the hollow body, such that a torque load can be applied. The shaft connection and/or the rotor connection furthermore preferably have/has cutouts for interlocking engagement with connecting elements. The cutouts may extend in the form of grooves in the axial direction or in the radial direction. In this case, projections, bolts, pins or the like on the rotor and/or on the shaft may engage as connecting elements in the cutouts for transmission of the torque. The cutouts can have a polygonal cross section with internally rounded corners. The interlocking engagement with connecting elements makes it possible not only to reliably transmit a torque which has been introduced into the torque transmission means from the rotor connection to the shaft connection, but also reduces the load on an additional screw connection which is used to provide the axial attachment between the shaft and the shaft connection and between the rotor and the rotor connection. The shaft connection and/or the rotor connection may for this purpose have screw holders in order to allow the shaft connection and/or the rotor connection to be screwed to the rotor and/or to the shaft.

The hollow body preferably has an essentially rotationally symmetrical form. The torque transmission means according to the invention can advantageously be used in rotating machines in which the rotor is provided with superconducting turns which preferably have a high-temperature superconductor material. Alternatively, a stator of the rotating machine can also be provided with coolable superconducting turns. The rotating machine is preferably a synchronous motor, but may also be a generator or the like. The turns of the rotor and/or of the stator can preferably be cooled by a suitable cooling apparatus, in order to allow the superconduction of the superconducting turns to be achieved in the operating state. The cooling apparatus may comprise suitable means in order to cool parts of the rotating machine, for example with liquid nitrogen, gaseous helium or the like.

These and other objects, aspects, features, developments and advantages of the invention of this application will become apparent to those skilled in the art upon a reading of the Detailed Description of Embodiments set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 shows a torque transmission means, in perspective; and

FIG. 2 shows the torque transmission means, connected to a rotor and to a shaft, from FIG. 1 in the form of a longitudinal section along the rotation axis.

### DETAILED DESCRIPTION OF EMBODIMENTS

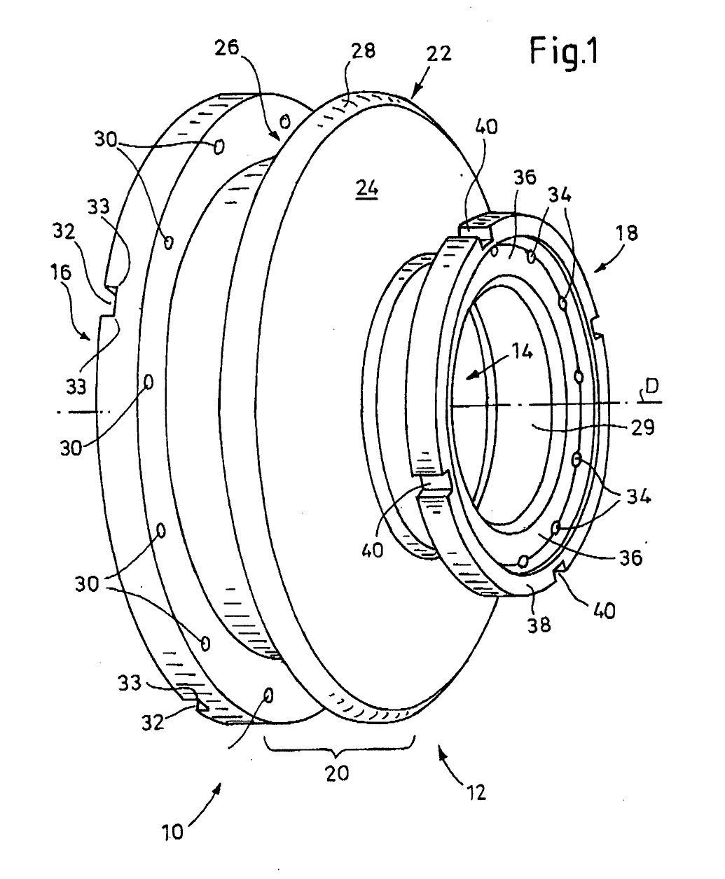

Referring now to the drawings wherein the showings are for the purpose of illustrating preferred and alternative embodiments of the invention only and not for the purpose of limiting same, FIG. 1 shows a torque transmission means or device 10 which is formed by a hollow body 12 which is essentially rotationally symmetrical about a rotation axis D. The hollow body 12 bounds an internal area 14 around a rotation axis D and opens or ends in a shaft connection 16 at the shaft end and in a rotor connection 18 at the rotor end. A rotor, which is not illustrated, of a synchronous motor can be connected to the rotor connection 18 and is provided with superconducting turns which must be cooled to temperatures of, for example, below 100 Kelvin by coolant and a suitable cooling apparatus, for their superconducting function. The shaft connection 16 can be connected to a shaft which is arranged on the rotation axis D but is not illustrated. In the operating state, the cooling-down of the rotor results in a considerable temperature gradient between the warm shaft connection 16 and the cooled rotor connection 18. The cooling-down of the rotor results in it contracting. Since the torque transmission means 10 is firmly connected to the rotor and to the shaft, this contraction is compensated for, according to the invention, by a length change of a compensation area of the hollow body 12. According to the invention, the hollow body 12 has a compensation area 20 between the shaft connection 16 and the rotor connection 18, which compensation area 20 can be compressed and can expand in the axial direction and absorbs axial stresses between the shaft connection 16 and the rotor connection 18. These stresses can occur as a result of the rotor cooling down to temperatures at which superconductors change to their superconducting state.

In the compensation area 20, the hollow body 12 is provided with a fold 22 which extends around the rotation axis D and is curved radially outward, in order to compensate for the length change and to absorb the stresses. The fold 22 widens the hollow body 12 in the compensation area 20. The fold 22 is formed by fold walls 24, 26 which are in the form of rings around the rotation axis D and form a V-shape with respect to one another. The fold walls 24, 26 are in this case connected to one another by means of a round fold back 28 along the circumference of the hollow body 12. When the rotor is colder than the shaft, then the rotor contracts and the hollow body expands in the axial direction in that the fold walls 24, 26, which form a V-shape with respect to one another, are bent slightly by the axial stresses and/or the included angle between the fold walls 24, 26 is increased.

The torque transmission device 10 is formed, apart from the shaft connection 16 and the rotor connection 18, from a poorly thermally conductive plastic such as epoxy resin in which a fiber material is embedded, overlapping and crossed over. The shaft connection 16 and the rotor connection 18 comprise steel rings and are screwed to the opposite ends of the hollow body 12, which is in the form of a plastic part. Since, in the compensation area, the hollow body 12 is produced from a poorly thermally conductive plastic, the heat introduced from the shaft to the cooled rotor can be kept low. Furthermore, the distance to be traveled by the heat energy is lengthened via the fold wall 26, the fold back 28 and the fold wall 24 in comparison to a tubular or conical hollow body. A further advantage is that a cylindrical section 29 of the hollow body is located between the compensation area 20 and the rotor connection 18, as a result of which the compensation area 20 is located closer to the shaft connection 16 than to the rotor connection 18 because this still allows the compensation area 20 with the fold 22 to be heated by the shaft such that the plastic essentially retains its modulus of elasticity in the area of the compensation area 20. The process of embedding fiber material, such as glass fibers or carbon fibers, overlapping and crossed over in this case allows the torque transmission means 10 to also transmit large torques reliably and in a torsionally-stiff form.

For connection of the shaft, which is not illustrated, the shaft connection 16 is provided with screw holders 30 concentrically around the rotation axis. Furthermore, the shaft connection 16 is provided with cutouts 32 which extend in the radial direction, are in the form of grooves, and are used for engagement with connecting elements, which are not illustrated, of the shaft. The shaft connection 16 is formed from a steel ring and is screwed to the hollow body 12. The cutouts, which are in the form of grooves and are milled into the steel ring, have an essentially polygonal cross section. Internal corners 33 in the cutouts are rounded.

The rotor connection 18, which is arranged at the opposite end of the hollow body 12 and is formed from a steel ring, has screw recesses 34, which are incorporated in a recessed end face 36 of the rotor connection 18. The end face 36 is bounded by a connecting ring 38, which projects axially beyond it. Four grooves 40 are arranged on the circumference of the connecting ring 38, in each case offset through 90° with respect to one another.

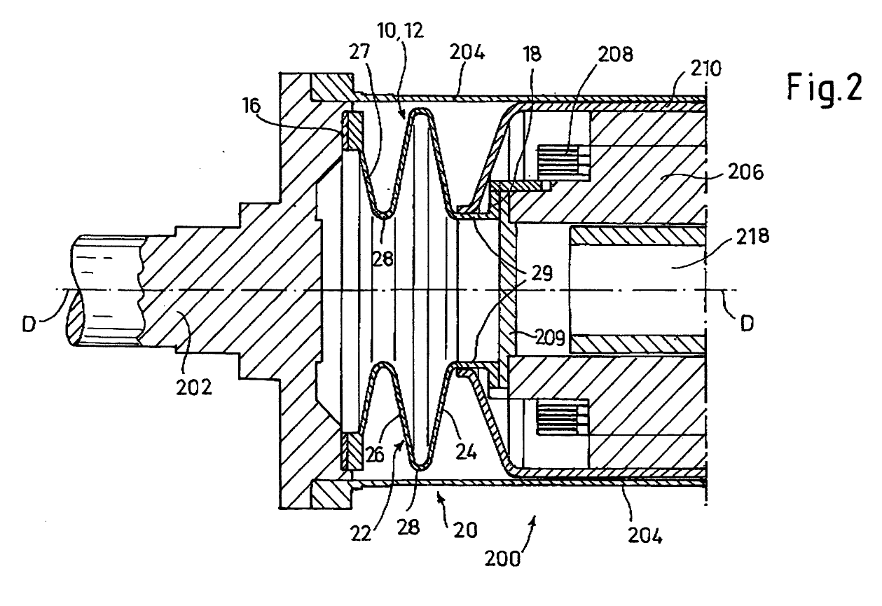

FIG. 2 shows a longitudinal section through a rotor 200 having a shaft 202 connected to it, which are connected to one another in a rotationally fixed manner by the torque transmission means 10 as shown in FIG. 1. The rotor 200 has a cylindrical housing 204 in which a coil former 206 with windings 208 composed of a superconducting material is held. The coil former 206 surrounds a cavity 218 which is bounded by a terminating piece 209. The coil former 206 with the winding 208 is surrounded by a sleeve 210, which is in turn held in a housing 204. The sleeve 210 narrows and surrounds the torque transmission means 10, which is connected to the terminating piece 209 by means of the rotor connection 18.

At the shaft end, the hollow body 12 is connected by means of the shaft connection 16 to the shaft 202 in a rotationally fixed manner but detachably by means of screw connections, which are not illustrated, and, at the rotor end, is connected by means of the rotor connection 18 to the terminating piece 209 of the rotor 200. The compensation area 20, which is in the form of bellows or is corrugated, with the fold 22 ends in the rotor connection 218 via the cylindrical section 29, which is surrounded by the sleeve 210, which narrows toward the hollow body 12. The compensation area is formed by three fold walls 24, 26, 27, which are connected to one another by means of the two fold backs 28. The shaft connection 16 is screwed to the fold wall 27, as a result of which the shaft connection 16 has a larger internal diameter than the rotor connection 18. In this embodiment, the compensation area 20 is formed from one and a half folds.

When the rotor 200 and/or adjacent areas of the rotor 200 are cooled down by means of a cooling apparatus, which is not illustrated, during operational use, the rotor contracts because of the temperature change, as a result of which the hollow body 12, which is screwed to the rotor 200 and to the shaft 202, is expanded in the compensation area 20 with the fold 22 which can be expanded and compressed axially, and the axial stresses which then occur between the rotor 200 and the shaft 202 are compensated for, in order that the torque is transmitted reliably. When the rotor 200 is once again heated to the ambient temperature of the shaft 202 after the cooling apparatus has been switched off, the rotor 200 expands and the hollow body 12 contracts to its original dimensions again, because of its capability to change length. As a result of the compensation area 20 being corrugated or in the form of a bellows, the effective length of the hollow body is greater than that of a cylindrical or conical hollow body. In sections of the compensation area 20 which are further away from the rotation axis D than a conical or cylindrical torque transmission means, the shear forces which are introduced with the torque are reduced, because of the greater distance from the rotation axis.

Numerous modifications will be evident to a person skilled in the art from the above description and are intended to be within the scope of protection of the attached claims. For example, a greater or lesser number of folds may be used than in the described exemplary embodiments. In addition, the side walls of the folds may be curved. Instead of providing a screw connection between the hollow body and the shaft connection and rotor connection, the metal elements can be embedded in the hollow body for connection purposes when the hollow body is being manufactured from fiber-reinforced plastic. The torque transmission means or device, including the shaft connection and rotor connection, may also be produced from plastic or some other poorly thermally conductive material. The rotating machine may be a synchronous motor which has a rotor with turns preferably composed of a high-temperature superconductor material.

Further, while considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-12. (canceled)

13. A torque transmission device for connecting, in a rotationally fixed manner, a shaft and a rotor of a rotating machine which has superconducting turns and which is coolable in order to create the superconducting state of these turns, the device comprising a torque-loadable hollow body which has a rotation axis and ends in a shaft connection at a shaft end and in a rotor connection at a rotor end, wherein, between the shaft connection and the rotor connection, the hollow body has a compensation area, which can expand in the axial direction, between the shaft connection and the rotor connection, in order to compensate for axial length changes resulting from temperature differences.

14. The torque transmission device of claim 13, wherein the hollow body is provided with at least one fold, which extends around the rotation axis.

15. The torque transmission device of claim 14, wherein the the at least one fold are formed by fold walls which form a general V-shape with respect to one another.

16. The torque transmission device of claim 15, wherein the the at least one fold are formed by rounded fold backs which merge into one another.

17. The torque transmission device of claim 13, wherein the hollow body is in the form of bellows in the compensation area.

18. The torque transmission device of claim 13, wherein at least one of the compensation area and the hollow body is composed of a poorly thermally conductive material.

19. The torque transmission device of claim 13, wherein the hollow body is produced from at least one of a fiber-reinforced and a glass-fiber-reinforced, plastic material.

20. The torque transmission device of claim 19, wherein the reinforcing fibers are embedded in the plastic material such that they overlap, crossed over.

21. The torque transmission device of claim 13, further including a cylindrical section located between the compensation area and the rotor connection.

22. The torque transmission device of claim 13, wherein at least one of the shaft connection and the rotor connection is formed with metal elements.

23. The torque transmission device of claim 13, wherein at least one of the shaft connection and the rotor connection has cutouts for interlocking engagement with the rotor-end or shaft-end connecting elements.

24. The torque transmission device of claim 23, wherein the cutouts extend in the form of grooves extending in one of the axial direction and the radial direction.

25. The torque transmission device of claim 24, wherein the cutouts have a polygonal cross section with internally rounded corners.

26. The torque transmission device of claim 23, wherein the cutouts have a polygonal cross section with internally rounded corners.

27. The torque transmission device of claim 13, wherein the axial length changes are adapted by the shape of the compensation area.

28. The torque transmission device of claim 13, wherein the shaft connection is connected with at least one of the shaft and the rotor connection by a connection means.

29. The torque transmission device of claim 13, wherein the connection means includes a screw connection.

30. The torque transmission device of claim 13, wherein the compensation area is closer to the shaft connection then to the rotor connection.
